(19) United States
(12) Patent Application Publication
(10) Pub. No.: US 2008/0235257 A1
(43) Pub. Date: Sep. 25, 2008

(54) CUSTOMIZING THE FORMAT OF WEB DOCUMENT PAGES RECEIVED AT REQUESTING COMPUTER CONTROLLED WEB TERMINALS

(76) Inventor: Scott Henry Berens, Austin, TX (US)

Correspondence Address: IBM CORPORATION;INTELLECTUAL PROPERTY LAW, 11501 BURNET ROAD, AUSTIN, TX, 78758, US

(21) Appl. No.: 11/690,168

(22) Filed: Mar. 23, 2007

(51) Int. Cl. G06F 7/00

(52) U.S. Cl. 707/102

(57) ABSTRACT

In a World Wide Web (Web) communication network with user access via a plurality of computer controlled interactive receiving display terminals, there is provided an implementation for transmitting, from a Web site, the content of said requested Web document as a stream of data combined with a function at the receiving terminal enabling a user to customize a format in which displayed Web documents are generated a function for generating said requested hypertext Web document in said customized format from the received stream of data.

### TECHNICAL FIELD

The present invention relates to computer managed communication networks such as the World Wide Web (Web) and, particularly, to systems, processes and programs for making the Web documents, i.e. pages, received from the Web more user friendly and easier to use through customization.

### BACKGROUND OF RELATED ART

The convergence of the electronic entertainment and consumer industries with data processing exponentially accelerated the demand for wide ranging communication distribution channels, and the Web or Internet commenced a period of phenomenal expansion. With this expansion, businesses and consumers have direct access to all matter of documents, media and computer programs via the Web.

In addition, Hypertext Markup Language (HTML), which had been the documentation language of the Web for years, offered direct hyperlinks between Web pages, embedded in such Web pages. This even further exploded the use of the Web.

As a result of this Web expansion, virtually all aspects of work in the industrialized world require human-computer Web interfaces. These changes have made computer directed activities accessible to a substantial portion of the industrial world's population which, up to a few years ago, was computer-illiterate, or, at best, computer indifferent.

Consequently, developers of Web documents/pages are continually working to make the handling of Web pages as simple and user-friendly as possible. Such simplification, of course, involves the interactive user to interface to Web documents or pages. At the present time, it is fairly easy and straight-forward for a user to print a Web page under the control of any standard Web browser program. Likewise, current Web browser programs enable the user to request to have the Web page downloaded and saved in its HTML format so that users may subsequently request that the browser fetch and display the Web page in its hypertext format whereby the user may still use the page hyperlinks to access linked documents.

However, the standard format of a requested Web document received at a computer display Web terminal has been relatively inflexible. In part, this has been due to the perceived need for HTML documents in order to browse through a hierarchy of hyperlinked Web documents. As a result of the inflexible format, the language, editing, as well as the shape and size of the Web page, the Web document has become fixed. In addition, there has been a lack of programming technology permitting the interactive user to simply make notes, sketches, highlight or otherwise annotate received Web pages for subsequent access and use by the user. While there are programs for the editing of HTML documents available in the art, these are relatively complex for most Web/Internet users/consumers because such programs require the acquisition of HTML operator skills.

There is a need for implementations enabling the less sophisticated Web user to avoid the current inflexibility of received Web pages to provide Web pages that retain the hypertext linked browsing capabilities but still permit the user to customize the Web page format to satisfy the aesthetic, functional and editing needs of the user.

### SUMMARY OF THE PRESENT INVENTION

The present invention is directed to a unique Web page function that enables the interactive user to customize the Web page format to satisfy the aesthetic, functional and editing needs of the user.

Thus, in a Web communication network with user access via a plurality of computer controlled interactive receiving display terminals for displaying requested hypertext Web documents of at least one display page containing text, images and embedded hyperlinks, the present invention provides a system for generating requested Web hypertext documents at a receiving terminal comprising conventional means, e.g. Web browser means, enabling a user at a receiving display terminal to request a hypertext Web document.

However, responsive to such a user request, there are alternative means for transmitting, from a site on said Web, the content of said requested Web document as a stream of data. There are means at the requesting user's receiving display terminal for enabling a user to customize a format in which displayed Web documents are generated, combined with means for generating the requested hypertext Web document in the customized format from said stream of data received at the receiving display terminal.

The stream of data may be transmitted in an applet format that has instructions enabling or aiding in the reading of the data stream by a Java Virtual Machine (JVM), preferably resident on the Web browser, at the receiving terminal. If there is no JVM at the receiving display terminal, the JVM may be transmitted as part of the applet including the data stream sent to the receiving terminal.

This implementation of the present invention enables the customization of the received Web pages so that the Web pages need not have the conventional rectangular format; the customized pages may be curvilinear or even triangular. The generated Web page should still be a hypertext document so that it has the conventional hyperlinks used to connect to other Web documents in the hierarchy of Web documents being browsed. Actually, the customized Web document may still be an HTML document. On the other hand, the present invention may enable the receiving display terminal to customize the Web document so that it has a more easily editable Microsoft Word™ or Lotus Wordpro™ format.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a Web portion upon which the present invention may be implemented;

FIG. 2 is a block diagram of a generalized data processing system including a central processing unit that provides the computer controlled interactive display system, as well as servers that may be used in practicing the present invention;

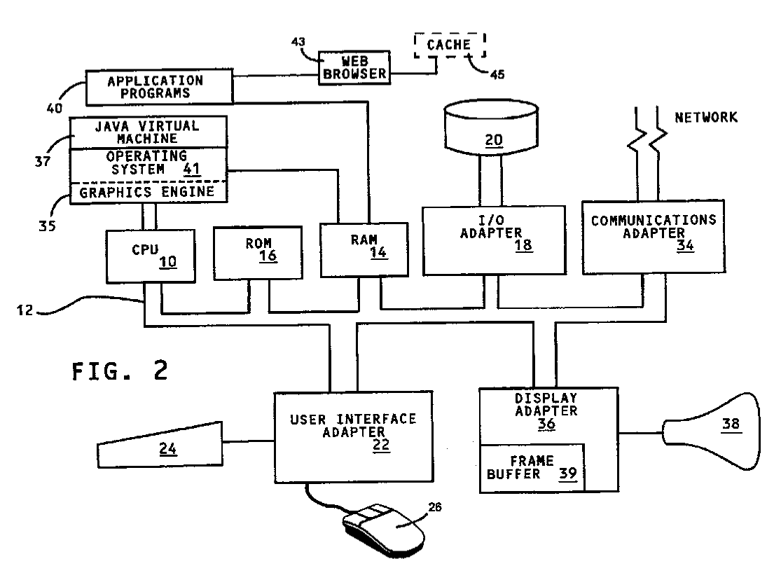

FIG. 3 is an illustrative flowchart describing the setting up of the process of the present invention for enabling the user to customize received Web documents;

FIG. 4 is a flowchart of an illustrative run of the process set up in FIG. 3; and

FIG. 5 is a flowchart of an illustrative generalized run illustrating how hyperlinks in a Web document generated from a data stream applet may be activated to access linked Web documents from Web sites.

### DETAILED DESCRIPTION OF THE PREFERRED EMBODIMENT

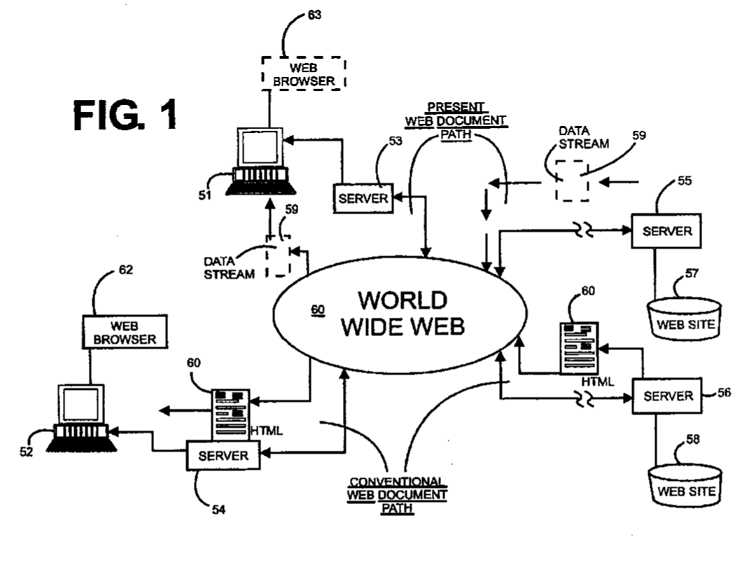

Referring to FIG. 1, there is illustrated a very generalized view of a network, e.g. Web, portion showing how individual participating users at network display terminals may be interconnected with appropriate Web sites that, for purposes of illustration, provide both conventional Web documents and streams of data that may be customized into formatted Web documents in accordance with the present invention. The present invention permits the access of Web documents by conventional methods, as illustrated by the Conventional Web Document Path shown in FIG. 1 and the invention's Present Web Document Path (also illustrated). Thus, when computer display terminal 52 selects to access a conventional HTML type document, its associated Web browser program 62 accesses a Web site illustrated by server 56 controlling database 58 that provides a conventional HTML Web document 60 via a transmission path including Web 50 and Web server 54 that may be provided by an Internet Service Provider (ISP) back to computer display terminal 52 where the conventional Web document is interactively displayed to the user in the conventional Markup Language format of text, images and hyperlinks to other Web documents as represented by page 60. Display terminal 52 is capable of accessing and displaying a requested Web page in the alternative user customizable format of the present invention, which will be illustrated by computer display terminal 51 on which a requesting user requests a Web document through its associated Web browser program 63 to thereby access a Web site illustrated by server 55 controlling database 57 that provides a stream of data 59 via a transmission path including Web 50 and Web server 53 that may be provided by an ISP back to computer display terminal 51. This data stream 59 is actually a portion of data from database 57 sufficient to provide the contents of the customized Web page to be formatted. It may be conveniently provided in a form readable by a JVM. Accordingly, the data stream may be in the form of an applet that has code or instructions that may facilitate the reading of the data stream. Such an applet would conveniently be a Java applet in the Java object oriented programming language that may be interpreted and implemented in a JVM program, usually present and available via the Web browser 63, as will hereinafter be described in greater detail. The basic functions of the JVM, its relation to objects therein and to the computer operating systems is described in detail at pp. 455-461 of the text, Java Jump Start, Noel Enete, published by Prentice Hall, New Jersey, 1997. This same text, at pp. 10-12 and 194-199, describes applets, particularly Java applets, and the relationship of applets to Web browsers, as well as the opening of such applets by JVMs.

The JVM program may already be present at the receiving display terminal 51 in association with Web browser 63. The JVM may have been previously accessed in the Web browsing session to open other applets, in which case it should be cached in association with browser 63. However, if the JVM is not available at the receiving display terminal 51, as will be described hereinafter in greater detail, the JVM may be included in the applet transmitted to terminal 51. In this case, the JVM may be opened and then used to generate a Web page according to the user's customized format from the transmitted data stream.

The customized format of the present invention enables the user to avoid the traditional rectangular format of the Web document/page if he so desires. For example, for particular needs in advertising, sales promotion or in electronic Web entertainment, e.g. games, non-rectangular shapes of Web pages may be desirable, e.g. triangular or curvilinear shapes. Also, for convenience in editing or in correlating with other documents, the user may wish to customize document contents accessed from the Web in word processing document or spread sheet document formats.

Thus, this invention further provides a virtual machine program in association with the receiving display terminal that treats the received data stream applet as a portion of a virtual Web site database at the receiving display station, the content of which may be formatted into a wide variety of user customized Web page formats including HTML formats. It should be noted that irrespective of the customized format of the user's Web document/page, it should preferably include hyperlinks to other Web documents and, thus, be a hypertext document.

As the present invention contrasts with the basic Web document or page, some background of the structure of the basic Web document is appropriate. The basic Web document is formatted in a markup language, usually HTML. The Java documentation program, JavaDoc, will produce standard HTML files for output to computer controlled displays to provide standard natural language displays of the program documentation. HTML is conventionally used for all forms of display documentation including the markup of hypertext and hypermedia documents, usually stored with their respective documents on a Web server in addition to the above-described programming distribution. HTML is an application of SGML (Standard Generalized Markup Language), an ISO standard for defining the structure and contents of any digital document. For further details on Java, JavaDoc or HTML, reference may be made to the texts, Just Java, 2nd Edition Peter van der Linden, published by Sun Microsystems, Mountainview Calif., 1997, or Java in a Nutshell, 2nd Edition, David Flanagan, O'Reilly publisher, 1997. Since the present invention is directed to an aspect of Web documents, transmitted over networks, an understanding of networks and their operating principles would be helpful. We will not go into great detail in describing the networks to which the present invention is applicable. Reference has also been made to the applicability of the present invention to a global network, such as the Internet or Web. For details on Internet nodes, objects and links, reference is made to the text, Mastering the Internet, G. H. Cady et al., 2nd Ed., 1996, SYBEX Inc., Alameda, Calif.

The Internet or Web is a global network of a heterogeneous mix of computer technologies and operating systems. Objects are linked to other objects in the hierarchy through a variety of network server computers. These network servers are the key to network distribution, such as the distribution of Web pages and related documentation. In this connection, the term “documents” is used to describe data transmitted over the Web or other networks and is intended to include Web pages with displayable text, graphics and other images. This displayable information may be still, in motion or animated, e.g. animated GIF images.

Web documents are conventionally implemented in HTML language, which is described in detail in the above-referenced text entitled, Just Java, particularly at Chapter 7, pp. 249-268, dealing with the handling of Web pages; and also in the aforementioned text, Mastering the Internet, particularly at pp. 637-642, on HTML in the formation of Web pages. The images on the Web pages are implemented in a variety of image or graphic files, such as MPEG, JPEG or GIF files, which are described in the text: Internet: The Complete Reference, Millennium Edition, Young et al., 1999, Osborne/McGraw-Hill, particularly at pp. 728-730.

In addition, aspects of this invention will involve Web browsers. A general and comprehensive description of browsers may be found in the Internet: The Complete Reference, Millennium Edition text mentioned above: Chapter 19, pp. 419-454, on the Netscape Navigator; Chapter 20, pp. 455-494, on the Microsoft Internet Explorer; and Chapter 21, pp. 495-512, covering Lynx, Opera and other browsers.

The present invention may be implemented using the Java programming system, which is an object oriented system utilizing the Java programming language. The Java system and language are very familiar to those skilled in the art. The text, Just Java, described above, comprehensively details this system and language. Nonetheless, it should be helpful to generally review the known principles of object oriented programming.

Reference is made to FIG. 1, which represents a typical data processing display terminal that may function as the computer controlled display terminal for receiving Web documents, as well as the various Web access servers and servers controlling Web site databases. A central processing unit (CPU) 10, such as one of the PC microprocessors or workstations, e.g. RISC System/6000™ (RS/6000) series available from International Business Machines Corporation (IBM) is provided and interconnected to various other components by system bus 12. An operating system 41 runs on CPU 10, provides control and is used to coordinate the function of the various components of FIG. 1. Operating system 41 may be one of the commercially available operating systems such as the AIX operating system available from IBM; Microsoft's WindowsXP™ or Windows 2000™, as well as various other UNIX and Linux operating systems. Application programs 40, controlled by the system, are moved into and out of the main memory Random Access Memory (RAM) 14. These programs include the programs of the present invention for enabling the user at a receiving terminal to customize the Web page format, as well as Web browser 43 and associated cache 45 on which a JVM 37 (shown here associated with operating system 41) may be temporarily stored when the JVM is accessed from the Web via an applet. In this connection, the JVM 37, when stored in RAM 14, coacts with operating system 41 and the stored customized format layout of the Web pages to be generated to use the graphics engine 35 of the operating system 41 to provide the customized Web pages of the present invention.

A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20 to provide the storage of the database of the present invention. Communications adapter 34 interconnects bus 12 with an outside network enabling the data processing system to communicate with other such systems over a Local Area Network (LAN) or a Wide Area Network (WAN) that includes the Web or Internet. I/O devices are also connected to system bus 12 via user interface adapter 22 and display adapter 36. Keyboard 24 and mouse 26 are all interconnected to bus 12 through user interface adapter 22. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

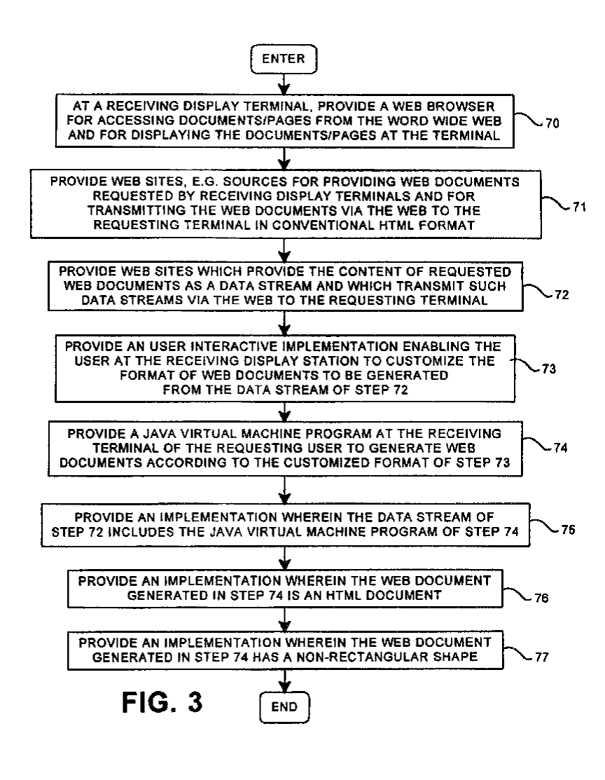

Now with reference to FIG. 3, we will describe the setting up of a system according to the present invention for providing an alternate customizable format for displayed received Web documents. At a receiving Web terminal there is provided a Web browser for accessing Web documents from the Web and for displaying such documents at the requesting terminal, step 70. There are provided conventional Web sites that provide the requested Web documents transmitted via the Web to the requesting terminal in convention HTML format, step 71. There are also provided Web sites that provide the content of the requested Web documents as a data stream in applet format transmitted over the Web to the requesting terminal, step 72. There is provided at requesting Web terminals an implementation enabling the terminal user to customize the received Web document formats, step 73. There is provided at the terminal enabling customization, a JVM for generating from the incoming data content stream, a Web document having the customized page format, step 74. Provision is made to include a JVM in the data stream (applet) being transmitted to the receiving terminal in the case where a JVM is not available at the receiving terminal, step 75. Although the present alternate approach is provided for generating Web documents having non-conventional formats, the method may still be used to generate conventional HTML documents from the received data content stream, step 76, in addition to the nonrectangular, e.g. circular or triangular documents, step 77.

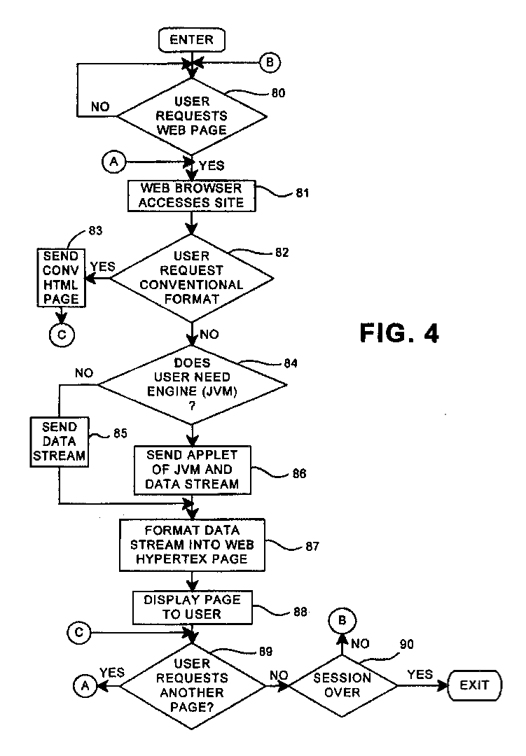

Now that the basic program set up has been described, there will be described with respect to FIG. 4, a flowchart of a simple operation showing how the program could be run. As the Web browsing session commences, a user request for a Web document is awaited, step 80. If Yes, the user requests a Web page, step 80, then the Web browser conventionally accesses the selected Web site, step 81. A determination is then made as to whether the user request is for a document of conventional HMLT Web page format, step 82. If Yes, a conventional Web page is accessed and transmitted, step 83. If No, then a data stream in the form of an applet is to be transmitted that will be formed into a Web document of user desired format. Thus, a determination is made as to whether the requesting user display terminal needs the JVM engine to generate the customized Web page from the data stream applet, step 84. If No, i.e. the terminal already has the JVM, then the data stream applet alone is sent, step 85. If Yes, the receiving terminal needs the JVM, then the JVM is embedded into the data stream applet that was sent, step 86. After either step 85 or 86, the received data stream is formatted into the customized Web page, step 87, and the Web page is displayed to the user, step 88. At this point, or after step 83 that is branched to this point by branch “C”, a determination is made as to whether the user has requested another Web page, step 89. If Yes, the process is returned to step 81 via branch “A”. If No, then a determination may conveniently be made as to whether the session is over, step 90. If Yes, the session is exited. If No, the process is returned to step 80 via branch “B”.

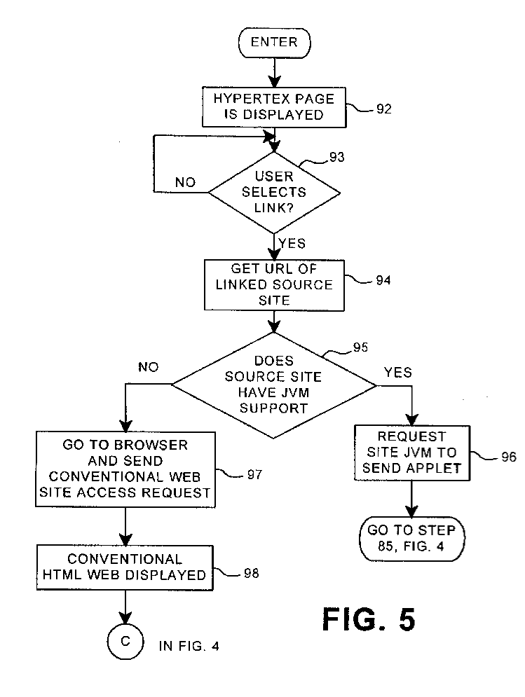

FIG. 5 is a flowchart of an illustrative generalized run illustrating how hyperlinks in a Web document generated from a data stream applet may be activated to access linked Web documents from Web sites. The Web document is displayed, step 92. A determination is made as to whether the user has selected a link in the displayed web document, step 93. If Yes, the URL of the linked Web site, source of the linked document, is determined, step 94. The URL of the linked Web document is stored in the data stream of the displayed Web document in association with the selected link. First, a determination is made as to whether the Web site from which the selected linked document is to be accessed has JVM support to create a Java applet data stream in accordance with the present invention, step 95. If No, the process accesses the Web browser in the receiving user terminal, which sends a conventional request for an HTML Web document accessed from the Web site, step 97, and that document is displayed. The process is then branched via “C” back to step 89 in FIG. 5. If the determination in step 95 is Yes, then a request is made to the Web site source of the linked document to create, via the site JVM, an applet data stream for the requested linked document, step 96, and the process is branched to step 85 in FIG. 4 wherein the data stream is sent to the receiving user terminal.

One of the implementations of the present invention may be in application program 40 made up of programming steps or instructions resident in RAM 14, FIG. 1, of a Web receiving station during various Web operations. Until required by the computer system, the program instructions may be stored in another readable medium, e.g. in disk drive 20 or in a removable memory, such as an optical disk for use in a CD ROM computer input or in a floppy disk for use in a floppy disk drive computer input. Further, the program instructions may be stored in the memory of another computer prior to use in the system of the present invention and transmitted over a LAN or a WAN, such as the Web itself, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. In a World Wide Web (Web) communication network with user access via a plurality of computer controlled interactive receiving display terminals for displaying requested hypertext Web documents of at least one display page containing text, images and embedded hyperlinks, a system for generating said requested Web hypertext documents at a receiving terminal comprising:
apparatus enabling a user at a receiving display terminal to request a hypertext Web document;
apparatus, responsive to said user requested apparatus, for transmitting, from a site on said Web, the content of said requested Web document as a stream of data;
apparatus, at said user's receiving display terminal for enabling a user to customize a format in which displayed Web documents are generated; and
apparatus for generating said requested hypertext Web document in said customized format from said stream of data received at said receiving display terminal.

2. The system for generating the requested Web hypertext documents of claim 1 wherein the stream of data is transmitted in an applet.

3. The system for generating the requested Web hypertext documents of claim 1 wherein said customized format provides said requested hypertext Web document in a nonrectangular format.

4. The system for generating the requested Web hypertext documents of claim 2 wherein said customized format provides said requested hypertext Web document in a curvilinear format.

5. The system for generating the requested Web hypertext documents of claim 2 wherein said customized format provides said requested hypertext Web document in a triangular format.

6. The system for generating the requested Web hypertext documents of claim 2 wherein the receiving computer controlled display terminal includes a Java Virtual Machine.

7. The system for generating the requested Web hypertext documents of claim 1 wherein said hypertext Web documents are generated in a Markup Language format.

8. In a World Wide Web (Web) communication network with user access via a plurality of computer controlled interactive receiving display terminals for displaying requested hypertext Web documents of at least one display page containing text, images and embedded hyperlinks, a method for generating said requested Web hypertext documents at a receiving terminal comprising:
enabling a user at a receiving display terminal to request a hypertext Web document;
transmitting, from a site on said Web, the content of said requested Web document as a stream of data responsive to said user request;
enabling a user to customize a format in which displayed Web documents are generated at said user's receiving display terminal; and
generating said requested hypertext Web document in said customized format from said stream of data received at said receiving display terminal.

9. The method for generating the requested Web hypertext documents of claim 8 wherein the stream of data is transmitted in an applet.

10. The method for generating the requested Web hypertext documents of claim 9 wherein said applet further includes a Java Virtual Machine for generating said Web hypertext document from said stream of data.

11. The method for generating the requested Web hypertext documents of claim 8 wherein said customized format provides said requested hypertext Web document in a nonrectangular format.

12. The method for generating the requested Web hypertext documents of claim 9 wherein said customized format provides said requested hypertext Web document in a curvilinear format.

13. The method for generating the requested Web hypertext documents of claim 9 wherein the receiving computer controlled display terminal includes a Java Virtual Machine.

14. The method for generating the requested Web hypertext documents of claim 8 wherein said hypertext Web documents are generated in a Markup Language format.

15. A computer program comprising a computer useable medium having a computer readable program, wherein the computer readable program, when executed on a computer, causes the computer to:
enable a user at a receiving display terminal to request a hypertext Web document;
transmit, responsive to said user request, the content of said requested Web document as a stream of data from a site on said Web;
enable a user to customize a format in which displayed Web documents are generated at said receiving display terminal; and
generate said requested hypertext Web document in said customized format from said stream of data received at said receiving display terminal.

16. The computer program of claim 15 wherein the stream of data is transmitted in an applet.

17. The computer program of claim 16 wherein said applet further includes a Java Virtual Machine for generating said Web hypertext document from said stream of data.

18. The computer program of claim 15 wherein the receiving computer controlled display terminal includes a Java Virtual Machine program.

19. The computer program of claim 15 wherein said hypertext Web documents are generated in a Markup Language format.

20. The computer program of claim 15 wherein said hypertext Web documents are generated in a customized nonrectangular format.
